(19) United States
(12) Patent Application Publication
(10) Pub. No.: US 2015/0227938 A1
(43) Pub. Date: Aug. 13, 2015

(54) TRANSACTION AUTHORISATIONS METHOD AND SYSTEM

(71) Applicant: MasterCard International Incorporated, Purchase, NY (US)

(72) Inventors: Patrik Smets, Nijlen (BE); Pablo Fourez, Scarsdale, NY (US)

(21) Appl. No.: 14/610,286

(22) Filed: Jan. 30, 2015

(30) Foreign Application Priority Data
Feb. 11, 2014 (GB) 1402355.0

(51) Int. Cl. G06Q 20/40; G06Q 20/32; G06Q 20/20

(52) U.S. Cl. CPC G06Q 20/40145; G06Q 20/202; G06Q 20/327

(57) ABSTRACT

A method and associated system for performing a transaction using biometric input from a cardholder 20 to establish both the presence of the cardholder at a point of sale 10, cardholder identification, and the cardholder's informed consent to a particular transaction, cardholder consent. In some embodiments, a single, unusual biometric input, such as placing the little fingers of both hands on a fingerprint scanner 24a, is detected at the point of sale 10 to establish both cardholder identity and cardholder consent in a single, convenient action.

### FIELD OF THE INVENTION

The present invention relates generally to transaction authorisation methods and associated systems. In particular, but not exclusively, the invention relates to enhancements to the security of transactions carried out through wireless payment devices. More particularly, the invention relates to account holder verification, using at least one biometric input.

### BACKGROUND OF THE INVENTION

Contactless payment transaction systems are well known. PayPass™ provides one such EMV™ compatible, contactless payment feature. Based on the ISO/IEC 14443 standard, it provides users with a simple, convenient way to perform transactions by tapping a payment card on a point-of-sale (POS) terminal, which comprises an appropriate reader, rather than swiping or inserting a payment card as has been done traditionally.

Typical PayPass-enabled payment cards comprise a chip, which may be the same as or similar to the chip or secure element present in a regular chip and PIN card, and an antenna connected to the chip. Payment details can be transmitted securely from the chip to a POS terminal by means of the antenna and the contactless interface.

In a typical contactless transaction, an electronic cash register sends details of a transaction to a PayPass™ or similarly enabled POS terminal. A PayPass-enabled payment card is placed or tapped against the POS terminal. The terminal activates and recognises the payment card which then securely transmits payment account details to the terminal. The account and transaction details are then processed by the same payment processing network used for regular transactions. The MasterCard™ operated Banknet™ is one such network.

Confirmation of the completion of a transaction may be provided within a fraction of a second after the payment card has been placed or tapped against the POS terminal.

For security reasons there is typically a payment limit on single contactless transactions (for example £20 in the UK). Where transactions exceed such a limit, a PIN may be requested. Also, typically, contactless cards can only be used a certain number of times before customers are asked for their PIN. Where a PIN is required it may be input via the terminal as with regular chip and PIN transactions.

More recently, MasterCard PayPass™ functionality has been developed for use with other form factors than payment cards, such as mobile phones. MasterCard Mobile PayPass™ makes use of near field communication (NFC) channels to enable mobile phones fitted with an NFC transceiver or transmitter (henceforth

NFC mobile phones) to act as payment devices. MasterCard Mobile PayPass™ enables contactless transactions to be made by placing or tapping a MasterCard Mobile PayPass™ enabled NFC mobile phone against a PayPass™ enabled POS terminal.

Mobile phones used as payment devices are usually required to comprise a secure element (SE) or be equivalently capable of providing for the secure hosting of applications and their confidential and cryptographic data. These requirements must be met in accordance with the rules and security requirements set forth by a set of well-identified trusted authorities such as the standard set by EMV™.

The user of such a payment device can download an application to the device which in turn allows payment card details to be downloaded onto it. An example application is the MasterCard Mobile PayPass™ application. An advantage of such a system over a regular payment card is that the applications stored on the SE may be remotely modified and also benefit from access to the device's user interface.

The transaction process for MasterCard Mobile PayPass™ transactions mirrors that of a PayPass™ payment card transaction.

In addition, more and more devices are being provided with longer range communication capabilities, such as Bluetooth, Wifi or other mid-range technologies, in conjunction with an SE, enabling transactions to take place at a greater distance from the POS than with NFC devices. A typical example of such a device is a mobile phone supporting Wifi or Bluetooth and equipped with an SE containing a payment application. It will be appreciated, however, that numerous other form factors can be envisaged, such as tablet computers, watches, keyfobs, and the like, so long as provided with the combination of an SE and the wireless communication capabilities. These will be referred to generically throughout the specification as payment devices.

A wireless point of sale can detect the presence of such a payment device and check that the payment application it holds is genuine. In payment terminology, this check is well known and is referred to as card authentication. The incorporation of the mid-range communication capability means that the check can be executed without inserting the card into the POS (as in the case of standard chip and PIN payment cards, for example, requiring physical insertion of the card chip into a reader at the POS) or bringing it into close proximity of the POS (as in the case of contactless NFC-enabled devices, which require a ‘tap’ of the payment device on the POS reader).

This process and system is illustrated in FIG. 1. A point of sale (POS) 10 comprises an electronic cash register 12 and a terminal 14. The electronic cash register 12 sends details of a transaction to the POS terminal 14, which is PayPass™ or similarly enabled. The terminal 14 has wireless communications capabilities, allowing it to establish wireless communication 16 with a payment device 18 held by a cardholder 20 within the communications range of the device/reader. For an NFC-enabled device, the appropriately configured payment device 18 is placed or tapped against the POS terminal 14. The terminal activates and establishes communications with the NFC circuitry in the payment device, which then securely transmits payment account details to the terminal. The account and transaction details are then processed conventionally, through a payment processing network 22. For devices having mid-range wireless communications capabilities, the tap is not required because the device 18 can be paired with the POS terminal 14 as soon as it is in range (as illustrated).

Additionally, where a PIN is required, for example when a transaction is above a pre-determined threshold of, say, £20, the PIN may be input via the payment device's user interface (UI). This step may be performed in advance of the device 18 being brought into range of the POS terminal 14 in anticipation of a PIN requirement. Alternatively, the PIN entry step may be performed on request:

following the establishment of communications between the POS terminal 14 and the payment device 18, a PIN may be requested, subsequently entered using the device's UI and the device then brought into range of the POS terminal again.

For simplicity and consistency of language, in the following, reference will be made to a payment card 18 and associated transaction steps, and a cardholder, rather than a payment device. It will be understood, however, that the description applies equally, mutatis mutandis, to other suitable payment device form factors, and a cardholder can, more generally, be considered as an account holder (with an account linked to a particular payment device).

The security of a card payment transaction relies on a combination of three elements:

(1) The authenticity and uniqueness of a payment card; ownership of the card gives access to the account. This proof of authenticity is often referred to as card authentication.

(2) The presence of the cardholder during the transaction. This ensures that the card is still in the hands of its legitimate owner and has not been lost or stolen. This proof of presence is often referred to as cardholder identification.

(3) The cardholder's consent to the transaction, to ensure that the cardholder knows what they are committing to.

The combination of cardholder identification (2) and cardholder consent (3) is often referred to as cardholder verification.

In current conventional transactions, the cardholder verification may be established by the cardholder inputting their PIN or their signature once the transaction amount has been displayed at the POS. That unique input proves, to a certain extent, that it is the legitimate cardholder that is present, and that they have consented to the transaction. Cardholder identification is achieved by having the card or issuer check the PIN or have the merchant compare the signature on the receipt with the one on the back of the card. If cardholder identification fails, the card reader or merchant typically rejects the transaction. The user experience is such that the PIN is typically entered after the display of the transaction amount; signature is on the final amount indicated on the receipt as well. Entering a 4 digit number associated to a payment application or signing a receipt is not something that is done unwittingly and without realizing the consequences.

More recently, biometric forms of input have been used with a view to increasing the security and making it more difficult to fake or forge the presence of the cardholder or their consent. Such biometric cardholder identification methods, which include biometric fingerprinting, face and voice recognition, are convenient and require little thought from the cardholder. Depending on how these biometrics are used, the outcome of the biometric verification can be used as a testimony to the fact that the cardholder was present during the transaction (=cardholder identification) or as a proof that the cardholder was present and did consent to the transaction (=cardholder verification).

One known transaction system that incorporates biometric input is provided by Natural Security. The system comprises a mid-range wireless device in combination with biometrics as a means of payment.

Such a wireless payment transaction system incorporating a biometric input is illustrated in FIG. 2. The system corresponds to that of FIG. 1 (and like parts are given the same references) but further includes a biometric input terminal 24. Using this system, card authentication is performed by establishing the pairing of the payment card 18 with the terminal 14 over the wireless communication 16 and by the terminal subsequently verifying the authenticity of the card details received by the terminal. In addition, cardholder identification is established by the biometric input terminal 24 detecting a biometric input of the cardholder. In the prior art, such as that of the Natural Solutions system, a single, natural biometric input is detected, and this does not necessarily indicate cardholder consent.

For example, a user will register their fingerprint on the Natural Security database, and subsequently present a single finger (typically the index finger, being the most natural) at a reader 24a at the POS for the fingerprint to be scanned and verified against that registered in the database to establish the presence of the cardholder at the POS. See FIG. 3a.

Such a system has a weakness, however, in that it focuses on convenience and provides cardholder identification through a natural gesture (the presentation of the single index finger). There are many reasons why a cardholder may put their index finger on a device and one can easily imagine scenarios in which a fraudster could exploit that weakness in the system. By way of example only, they could install a (fake) terminal disguised as a gate and invite an unwitting cardholder to push a button. The button push would allow the fake terminal to collect the fingerprint, have it validated by the cardholder device and collect the payment credentials from the cardholder device. If the fraudster has an account with an acquiring bank, he can submit the payment transaction and collect the funds without knowledge and consent of the cardholder.

Likewise, alternative biometric inputs may be susceptible to similar fraudulent exploitation. By way of example, in a voice recognition system, a user may register a recording of their speaking their name on a database for subsequent identification purposes. A fraudster could trick the user into speaking their name 30 into a microphone 24b, have it validated by the cardholder device and collect the payment credentials from the cardholder device. See FIG. 3b. Similarly, in a simple facial recognition system, where a user's neutral expression 32 is registered on a database, a camera 24c set up by a fraudster could easily catch the user with that neutral expression and thereby have it validated by the cardholder device and collect the payment credentials from the cardholder device. See FIG. 3c.

There is therefore a need to prevent such fraudulent exploitation of biometric inputs in conjunction with the convenience of mid-range wireless card technology.

### SUMMARY OF THE INVENTION

According to a first aspect of the invention, there is provided a method of performing a transaction, the method comprising: authenticating a payment account; and establishing account holder verification by: detecting a predetermined biometric input from the account holder to establish the presence of the account holder at a point of sale; and detecting an ancillary predetermined user input from the account holder to establish the account holder's consent to the transaction.

By including both a (primary) predetermined biometric input and an ancillary predetermined user input, the chances of an account holder inadvertently consenting to a transaction through an accidental (or fraudulently induced) biometric input are reduced.

Preferably, detecting the predetermined biometric input comprises one or more of: fingerprint recognition, voice recognition, facial recognition, vein pattern recognition, retinal scanning, and gait analysis.

Detecting the ancillary predetermined user input typically comprises one or more of: detecting a particular combination of fingers on a scanner, detecting a particular phrase or pattern of phonemes, detecting a particular gesture, detecting a particular facial expression, keypad input of a PIN, electronic capture of the user's signature, detecting a pairing between a payment device associated with the payment account and the terminal, and detecting pre-registered consent to particular transactions. Such inputs require specific, deliberate action from the account holder and as such are not likely to be done inadvertently.

Preferably, detecting the predetermined biometric input and detecting the ancillary predetermined user input are carried out in a single combined step. This is easy and convenient for the account holder.

Authenticating the payment account may comprise: establishing secure communication between a payment device associated with the payment account and a terminal at the point of sale; sending an authorisation request message from the terminal to the issuer associated with the payment account; and receiving, at the terminal, an approval message from the issuer. The communication between the payment device associated with the payment account and the terminal may be established wirelessly (e.g. through the regular Bluetooth™ or WiFi discovery process) or may be the result of a hand-over from NFC to a Bluetooth™ or WiFi protocol.

The method may further comprise informing the user of the transaction amount prior to one or both of detecting the predetermined biometric input and detecting the ancillary predetermined user input. In this manner, the account holder is aware of the transaction amount prior to giving their content to the transaction through the biometric and ancillary user inputs, so the consent is an informed one.

In certain embodiments, establishing account holder verification is only required for transactions above a predetermined value.

The method may, in some embodiments, further comprise determining whether a payment device associated with the payment account is within a predetermined area, and only requiring detection of an ancillary predetermined user input if the device is not within such a predetermined area. This allows for a user to set defined areas where it is not required for the ancillary input to be made in order for a transaction to take place. By way of example, a user can state that they want to be able to consent to a transaction at a given merchant location only by a single biometric input (such as a single-digit fingerprint). This may, in some circumstances, be more convenient for the user.

The payment device associated with the payment account may comprise a secure element in any convenient form factor. Commonly, this would take the form of a payment card, or an element within a smartphone or other portable computing device, but likewise many other form factors are known and can be envisaged. Where it is intended for such a payment device to be able to communicate wirelessly with the terminal, the device would further comprise a communications interface for establishing that wireless communication.

According to a second aspect of the invention, there is provided a transaction system comprising: a point of sale terminal for processing a transaction; means for authenticating a payment account; a biometric input device in communication with the terminal for detecting and verifying a predetermined biometric input to establish the presence of the account holder; and means, in communication with the terminal, for detecting an ancillary predetermined user input from the account holder to establish the account holder's consent to the transaction.

The point of sale terminal is typically in communication with a transaction processing and authorising system.

The authenticating means may be configured to detect the presence of an authentic payment account in the payment device.

The biometric input device may comprise any or all of: a microphone, a fingerprint scanner, a finger vein detector, a camera, a facial recognition device and a gait analysis device.

### BRIEF DESCRIPTION OF THE DRAWINGS

Embodiments of the present invention will be described, by way of example only, with reference to the accompanying drawings, in which:

FIG. 1 shows a known wireless payment transaction system;

FIG. 2 shows a wireless payment transaction system including a biometric input terminal;

FIGS. 3a to 3c illustrate different known biometric input options that can be used to prove cardholder identification;

FIGS. 4a to 4c illustrate specific biometric inputs according to embodiments of the invention that can be used to ensure cardholder consent; and

FIG. 5 is a flow chart of methods of performing a transaction according to embodiments of the invention.

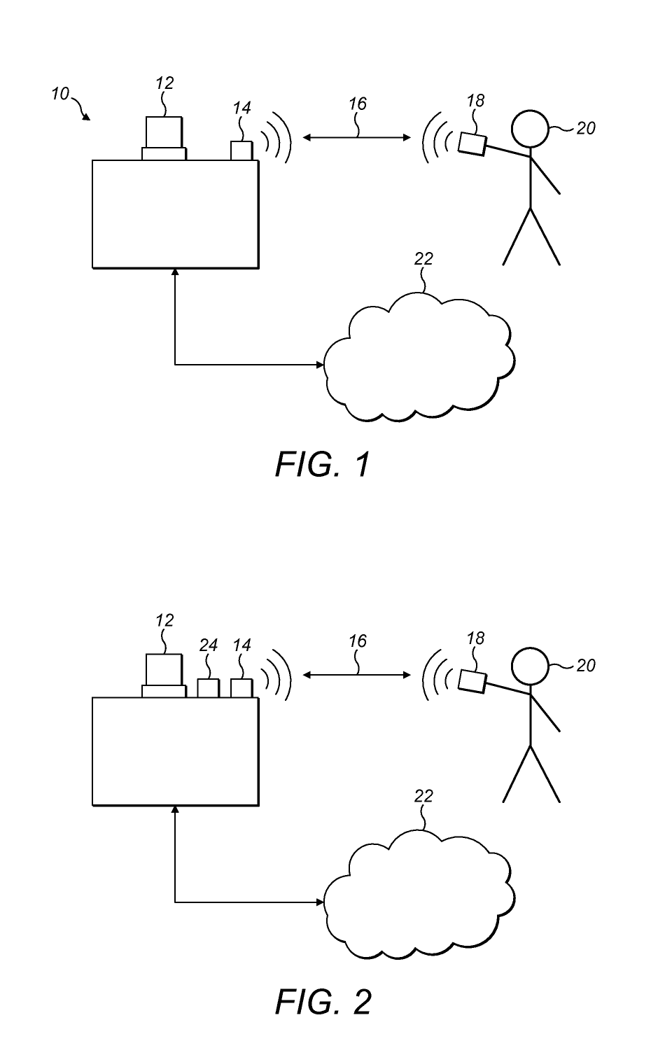

### DETAILED DESCRIPTION

A wireless payment transaction system according to the invention may use the same hardware as for the known system illustrated in FIG. 2. However, rather than being set up to establish a single, natural biometric input—which does not necessarily indicate cardholder consent—cardholder identification and cardholder consent are both established. This is achieved by detecting not only a predetermined biometric input from the cardholder to establish their presence at the point of sale, but also an ancillary predetermined user input to establish their consent to the transaction. Card authentication and/or cardholder identification may require communication with the payment processing system 22 and the issuer of the payment account.

The (primary) predetermined biometric input from the cardholder may be in the form of conventional fingerprint recognition, voice recognition, facial recognition, vein pattern recognition, retinal scanning, or gait analysis. This input may be active, requiring the cardholder to take a specific action for a biometric parameter to be input, such as by placing a finger on a scanner at the biometric input terminal 24 for detection of the user's fingerprint of vein pattern. Alternatively, the input may be passive, for example by automatic detection of the parameter by a camera linked to the input terminal 24, as might be suitable for facial recognition or gait analysis.

The ancillary predetermined user input is a secondary input that would not occur inadvertently; instead requiring the user to perform a deliberate action, thereby indicating their consent to the transaction.

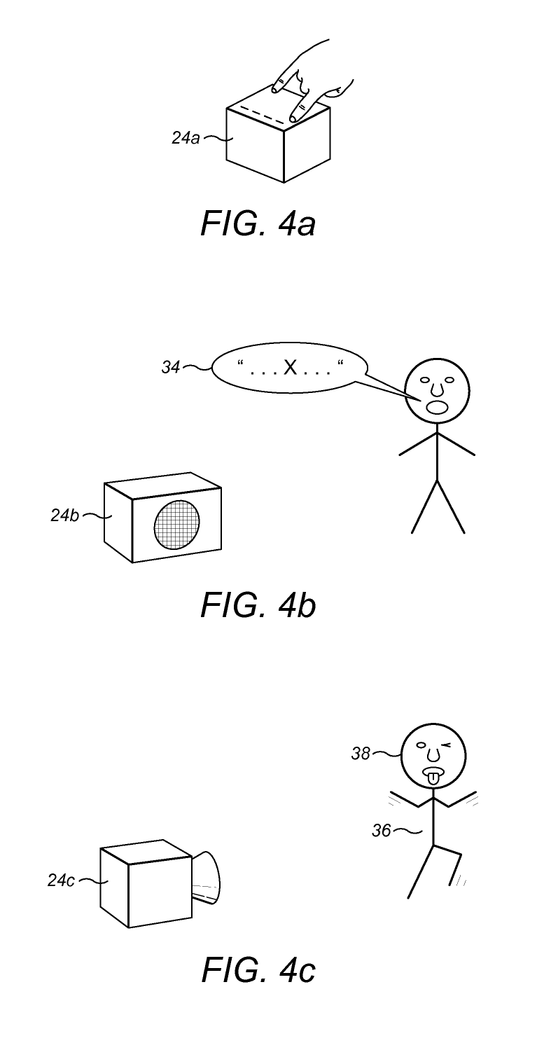

The ancillary input may comprise detecting a particular action, e.g. an unusual combination of fingers on a scanner 24a linked to the input terminal 24 (FIG. 4a), detecting a particular phrase or pattern of phonemes 34 through a microphone 24b linked to the input terminal 24 (FIG. 4b), or detecting a particular action 36, gesture or facial expression 38 through a camera 24c linked to the input terminal 24 (FIG. 4c). Other examples of suitable ancillary inputs include: input of a PIN, for example via a keypad (not shown) linked to the input terminal 24, or via a user interface on their payment device 18; and electronic capture of the user's signature, for example on a user interface (not shown) at the input terminal 24. In these examples, the ancillary input would typically be made by the cardholder after having been presented with the transaction amount, for example via a display at the point of sale 10, such that the consent is an informed one.

Where a PIN is used as ancillary user input in conjunction with a primary biometric input, the biometric input is used to identify and select the payment card 18 belonging to the cardholder 20 in front of the POS 10 (and eliminate devices belonging to other cardholders) and functions as a first level of cardholder identification. The PIN provides a second level of cardholder identification and cardholder consent.

The ancillary input may occur simultaneously with the primary biometric input.

As an alternative, the ancillary user input may comprise the cardholder 20 tapping their payment card 18 on the POS terminal 14 to establish a pairing between the payment card 18 and the POS terminal 14, thereby indicating a first level of cardholder consent to a transaction at that terminal, perhaps within a defined timeframe. The primary user biometric input (such as a fingerprint) can then be captured after the final transaction amount has been displayed and is used as cardholder identification and a second level of cardholder consent (now informed as to the specific amount).

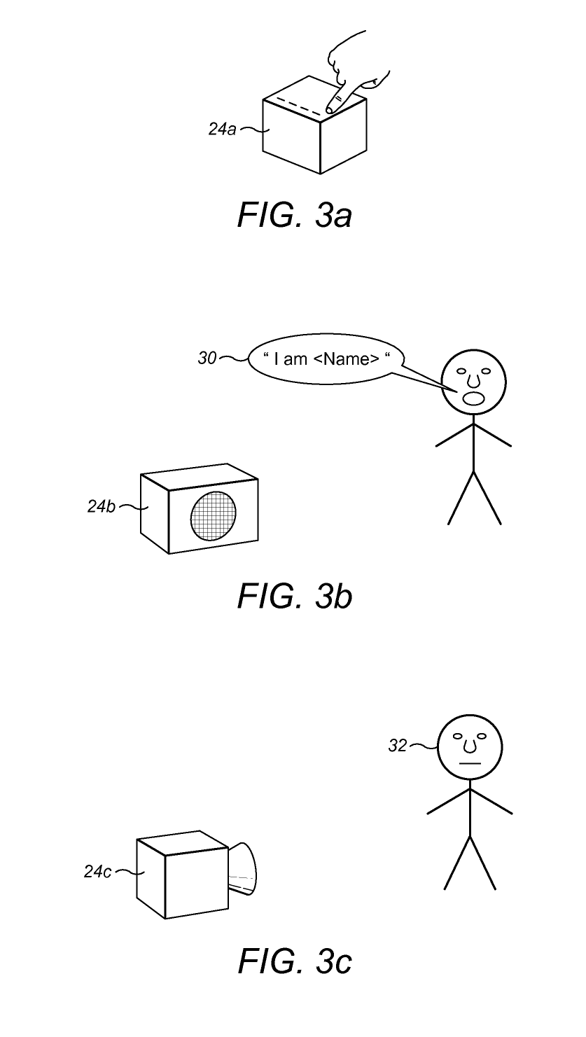

An example to illustrate the distinction between primary biometric input and ancillary input for voice recognition:
If a person is identified by means of their voice pattern, independent of what this person says (i.e. independent of the content of a sentence), or perhaps by virtue of them saying their name 30, the biometric only identifies the person and—depending on the quality of the biometric—proves presence of this person, i.e. cardholder identification. (See FIG. 3b.)
If, however, the voice recognition requires a well-defined sentence 34 (with some variable elements) that would not be used in other circumstances (e.g. “I agree to pay the sum of . . . to . . . ”), the voice recognition may be used to prove both presence and consent, i.e. cardholder verification. (See FIG. 4b.)

A similar analysis can be made for biometric fingerprints:
If a person is identified by their pre-registered fingerprint, then this merely proves their presence (cardholder identification), because the fingerprint scan can be obtained in a variety of circumstances, such as the above example in which they are using their index finger to push a button to open a door. (See FIG. 3a.)
If, however, this person is requested to present their two little (pinky) fingers at the same time to conclude a payment, then this could be used as proof of both presence and consent (cardholder verification), because the act of presenting two little fingers is so peculiar that it would not be used for other purposes. Because it is so specific, it can be associated to the particular context of payment and consenting thereto. Other unusual combinations of fingers could also be used, such as the index and little fingers from a single hand, as illustrated in FIG. 4a.

The above-described additional security measures of combined primary and ancillary user input to ensure cardholder consent may only be requested for certain transactions, for example for high value transactions over a predetermined value.

In certain embodiments, instead of the cardholder giving their consent at the POS 10, they may do so in advance, prior to check-out. By way of example, through geo-location (GPS) and/or beaconing, the cardholder device 18 can detect when the device is in the vicinity of a particular shop and inform the cardholder 20 about the payment options available inside. Payment options may include solutions such as biometric payment through the Natural Security solution discussed in the introduction. The cardholder might, for example, be asked to confirm, through the device's user interface, that they consent to the use of such payment options. Through this interaction between the cardholder 20 and the cardholder device 18, the cardholder is made aware of the context and the consequences of tapping a finger at the input terminal 24 (or providing other biometrics), while being in the shop.

Hence, a biometric initiated checkout (and payment) (e.g. by scanning a fingerprint) is only enabled after the cardholder has acknowledged this context and has awareness of the consequences. This acknowledgment is only valid within the boundaries of the shop. Under these conditions, context has been created and cardholder consent has been obtained. At check-out, the fingerprint validation functions as cardholder identification and combined with the cardholder consent done at entry, constitutes cardholder verification.

When leaving the shop, through geo-location, the cardholder device 18 updates the context and resets the acknowledgment so that the possibility of biometric checkout and payment is now deactivated.

Going one step further, the cardholder 20 may decide that the above interaction around the payment options is not required each time the shop is entered. The cardholder may pre-register with the shop or a number of shops so that upon entry of the shop one or more payment options are activated automatically (and deactivated automatically when leaving the shop). As the automatic activation is based on location, it mitigates against a fraudster pretending to be an authorized shop and thereby fraudulently obtaining payment credentials without the cardholder's consent.

Similarly, the customer may enable automatic biometric checkouts without acknowledgement only for transactions below a certain monetary value.

Consumers could register various payment options offered in a mobile/cloud wallet. The cardholder 20 may enable and select amongst different payment options within the wallet through the cardholder device 18, and set different preferences for various payment methods, indicating which payment option can be used following a checkout with biometric identification (e.g. a fingerprint scan). These payment preferences may be set by the cardholder, may be specific for each shop, and may be changed by the cardholder at any time, for example upon entry into the shop and activation of a biometric checkout option.

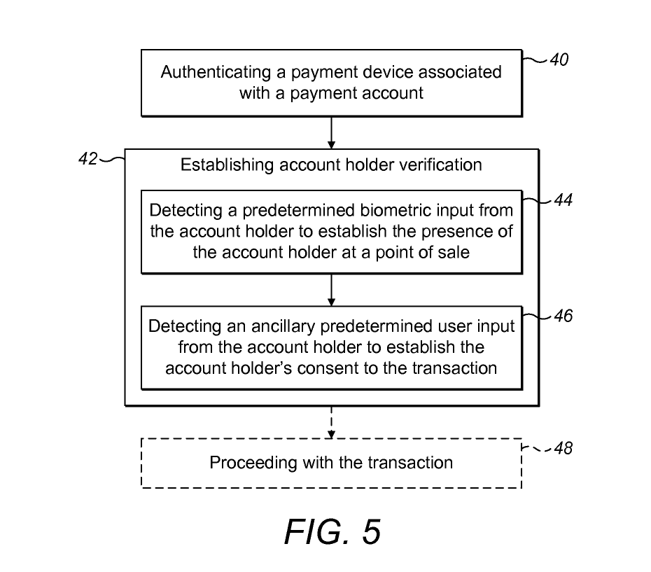

FIG. 5 shows a flow chart of transaction processes performed according to an embodiment of the invention.

When a transaction is to be performed at a point of sale 10, in step 40, a payment device 18 associated with a payment account is authenticated. This step may be performed in a conventional manner, which may involve data exchange between the point of sale terminal 14 and the issuer entity (not shown) associated with the payment account, typically via a third party payment processing system 22. This step 40 may require a sub-step of detecting the payment device and establishing communications therewith; typically wirelessly.

In step 42, account holder verification is established through the sub-steps of: detecting a predetermined biometric input from the account holder to establish the presence of the account holder 20 at the point of sale 10 (step 44); and detecting an ancillary predetermined user input from the account holder 20 to establish the account holder's consent to the transaction (step 46). The predetermined biometric input and the ancillary predetermined user input are as described above.

Once steps 40 and 42 have been completed, the process may continue by proceeding with the transaction (step 48).

Many modifications and variations may be made to the above-described embodiments within the scope of the invention.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A method of performing a transaction, the method comprising:
authenticating a payment account; and
establishing account holder verification by:
detecting a predetermined biometric input from the account holder to establish the presence of the account holder at a point of sale; and
detecting an ancillary predetermined user input from the account holder to establish the account holder's consent to the transaction.

2. The method according to claim 1, wherein detecting the predetermined biometric input comprises at least one of: fingerprint recognition, voice recognition, facial recognition, vein pattern recognition, retinal scanning, and gait analysis.

3. The method according to claim 1, wherein detecting the ancillary predetermined user input comprises at least one of: detecting a particular combination of fingers on a scanner, detecting a particular phrase or pattern of phonemes, detecting a particular gesture, detecting a particular facial expression, keypad input of a PIN, electronic capture of the user's signature, detecting a pairing between a payment device associated with the payment account and the terminal, and detecting pre-registered consent to particular transactions.

4. The method according to claim 1, wherein detecting the predetermined biometric input and detecting the ancillary predetermined user input are carried out in a single combined step.

5. The method according to claim 1, wherein authenticating the payment account comprises:
establishing secure communication between a payment device associated with the payment account and a terminal at the point of sale;
sending an authorisation request message from the terminal to the issuer associated with the payment account;
receiving, at the terminal, an approval message from the issuer.

6. The method of claim 5, wherein the communication between the payment device associated with the payment account and the terminal is established wirelessly.

7. The method of claim 6, wherein the communication between the payment device associated with the payment account and the terminal is according to a hand-over from NFC to a Bluetooth™ or WiFi protocol.

8. The method of claim 1, further comprising informing the user of the transaction amount prior to one or both of detecting the predetermined biometric input and detecting the ancillary predetermined user input.

9. The method of claim 1, wherein establishing account holder verification is only required for transactions above a predetermined value.

10. The method of claim 1, further comprising determining whether a payment device associated with the payment account is within a predetermined area, and only requiring detection of an ancillary predetermined user input if the device is not within such a predetermined area.

11. The method of claim 5, wherein the payment device associated with the payment account comprises a secure element in any convenient form factor.

12. The method of claim 11, wherein the communication between the payment device associated with the payment account and the terminal is established wirelessly and further wherein the payment device comprises a communications interface for establishing wireless communication with the terminal.

13. A transaction system comprising:
a point of sale terminal for processing a transaction;
means for authenticating a payment account;
a biometric input device in communication with the terminal for detecting and verifying a predetermined biometric input to establish the presence of the account holder; and
means, in communication with the terminal, for detecting an ancillary predetermined user input from the account holder to establish the account holder's consent to the transaction.

14. The system of claim 13, wherein the point of sale terminal is in communication with a transaction processing and authorising system.

15. The system of claim 13, wherein the authenticating means is configured to detect the presence of an authentic payment account in the payment device.

16. The system of claim 13, wherein the biometric input device comprises at least one of: a microphone, a fingerprint scanner, a finger vein detector, a camera, a facial recognition device and a gait analysis device.
